(19) United States
(12) Patent Application Publication
(10) Pub. No.: US 2006/0096020 A1
(43) Pub. Date: May 11, 2006

(54) Spa switch

(76) Inventors: Jose A. Caudilo, Oceanside, CA (US); Timothy P. Pflueger, Escondido, CA (US)

Correspondence Address: FISH & RICHARDSON, PC, P.O. BOX 1022, MINNEAPOLIS, MN, 55440-1022, US

(21) Appl. No.: 10/984,278

(22) Filed: Nov. 8, 2004

(51) Int. Cl. A61H 33/06; A47K 3/00; A47K 3/10

(52) U.S. Cl. 4/541.1

(57) ABSTRACT

A spa control system controlled by an infrared beam. In one implementation, the spa control system has a sender device located at a target sender area of spa shell, and a receiver device located at a target receiver area of a spa shell. The system includes receiver electronics associated with the receiver device, in which the receiver electronics are configured to transmit a signal when a path of the infrared beam is interrupted. The system also includes one or more control units of the spa to receive the signal, and to adjust a function of the one or more control units according to the signal received.

### CROSS REFERENCE TO RELATED APPLICATIONS

This application is related to an U.S. application entitled “SPA CAPACITIVE SWITCH”, filed Nov. 8, 2004 by Brent Hutchings.

### TECHNICAL FIELD

The present disclosure relates to control switches for spas.

### BACKGROUND

The sophisticated safety requirements and operational features of today's spas, pools and hot tubs allow design engineers to add more peripheral features that enhance the user's experience.

Spa controls can be in various locations in a spa. In one example, the controls are on the outside of the spa. In that example, the spa user has to go outside of the spa to change a switch for water flow, water heating, water level within the spa, and/or other spa accessories. For instance, controls are typically located in the front of the spa unit. Various switch configurations have been implemented to allow the user to perform these actions from the seating area of the spa.

In another example, the controls and knobs of the control system may be subject to the harsh environment of the spa, such as the heat of the water and the corrosive environment of exposure to the water in the spa, as well as from potential leakage from the seals around the controls and knobs. In particular, mechanical contact switches can be susceptible to dirt, corrosion, seal leaks, wear, and contamination. In addition, if the control switch is located below the waterline, replacement of the control components may be time-consuming and labor-intensive, with expensive draining and refilling of the spa. Other costs of mechanical switches may include watertight seals, molded buttons, and permanent magnets

Although much of the peripheral “on/off” switching can be done from a central spa control user interface, there can be other operations that would benefit from distributing the switch operations around the spa at locations that are spatially relevant to the activity. For example, if a user sits in a certain seat near a control switch, the jet pump for that seat can be energized and then de-energized without the user leaving the seat. For such localized switching, some system designs may have mechanical switches or magnetic switching. Mechanical switch implementations may use a mechanical connection with watertight sealing through the spa enclosure. In a magnetic switch implementation, a user may press a magnet-filled button against the spa enclosure and a resulting magnetic field can be detected via a mechanical reed switch. One such magnetic switch implementation is U.S. Pat. No. 6,775,863 B2 to Hutchings.

### SUMMARY

The present disclosure describes a spa control system that, in one implementation, includes a spa shell and a sender device located at a target sender area of the spa shell. The sender device is operable to send an infrared beam. The system includes a receiver device located at a target receiver area of the spa shell, in which the sender device is operable to receive the infrared beam. The system has receiver electronics coupled with the receiver device that are operable to transmit a signal when a path of the infrared beam is interrupted, and one or more control units of the spa to receive the signal and to adjust a function of the spa according to the signal received.

In another implementation, a method to control a spa involves forming an infrared beam across an area of the spa, and receiving user input to adjust at least one spa function. The user input includes an interruption of a path of the infrared beam. The method includes converting the user input into a signal, sending the signal to a controller unit located inside of a spa shell, and adjusting the spa function based on the received user input.

Another implementation involves an apparatus to control one or more spa operations. The apparatus includes electrical components operable to detect whether an infrared beam formed across an area of a spa is interrupted, convert the detected infrared beam interruption into a signal, send the signal to a spa control unit, and control a spa control unit using the signal.

The systems and techniques described here may provide one or more of the following advantages. For example, an infrared sensor may have no moving parts in the spa interior to break from abuse or normal wear and tear. As a result, there may be a reduction of potential leakage points at a mechanical connection or at an internal actuator within the spa enclosure when compared to conventional mechanical switches. The infrared switches can provide a number of different locations in the spa to place the switches. The spa user can control spa functions while remaining within the spa. The infrared switches can be easy to operate, in that breaking an infrared beam can change a state of a spa function and activate or deactivate the spa function. The infrared beam can be broken by simple movements of the user, such as using a hand to break the beam.

Details of one or more implementations are set forth in the accompanying drawings and the description below. Other features and advantages will be apparent from the description and drawings, and from the claims.

### DRAWING DESCRIPTIONS

FIG. 1A illustrates a diagram of a top view of a spa.

FIG. 1B illustrates a diagram of a seating area view of the spa shown in FIG. 1A.

FIGS. 2A-2E illustrate various locations of sensors in the spa.

FIG. 3 is an exemplary operational flowchart for the spa switch.

FIG. 4 shows a diagram of spa function control.

Like reference symbols in the various drawings indicate like members.

### DETAILED DESCRIPTION

The following detailed description makes reference to the accompanying drawings. Other implementations of the present invention are possible and modifications may be made to the implementations without departing from the spirit and scope of the invention. Therefore, the following detailed description is not meant to limit the invention. Rather the scope of the invention is defined by the appended claims.

Moreover, for convenience in the ensuing description, some explanations of terms are provided herein. However, the explanations contained herein are intended to be exemplary only. They are not intended to limit the terms as they are described or referred to throughout the specification. Rather these explanations are meant to include any additional aspects and/or examples of the terms as described and claimed herein and/or as used by one of skill in the art.

The following describes various techniques and systems relating to a switch for a spa that is based on infrared light. The switch uses a “through-beam” technique to detect a presence of an object or a spa user's body (e.g., a hand or foot) and use that detection to control at least one function of the spa. In the “through-beam” technique, an infrared beam is sent from a first area of the spa to a second area of the spa. If a user breaks the infrared beam, for example, by placing a hand in the path of the beam, then electronics associated with the infrared beam detects that the beam has been broken and sends a signal to a spa control unit. The infrared beam may be considered to be interrupted when an infrared receiver unit does not receive the infrared beam from an infrared sender unit. The spa control unit may control one or more spa functions, such as controlling water jets or water temperature, and can adjust the spa functions according to the signal received from the infrared beam electronics. The spa control unit may be located within the spa enclosure, and kept away from the water within the spa seating area. A spa control system can support multiple infrared switches at multiple locations throughout the spa.

In one implementation, “beam targets” can be demarcated with a decorative design, a printing, a label, a molding, a pattern, or a texture in the spa shell enclosure. The “beam target” can refer to an area of the spa shell enclosure that is either sending or receiving an infrared beam. In one implementation, there are two beam targets, in which one beam target can be part of the sending or originating point of the infrared beam, and a second beam target can be the ending or terminal point of the beam.

As used herein “infrared switches” may include “infrared sensors”. In one aspect, the infrared switch may include an infrared sender component and an infrared receiver (e.g., detector) component, as well as electronics associated with the sender and receiver component. In another aspect, infrared sensors may more generally refer to beam sensors, and may include the sender and receiver components at the originating beam target and the terminating beam target, respectively. The switch may be coupled to a spa control unit to control one or more spa functions.

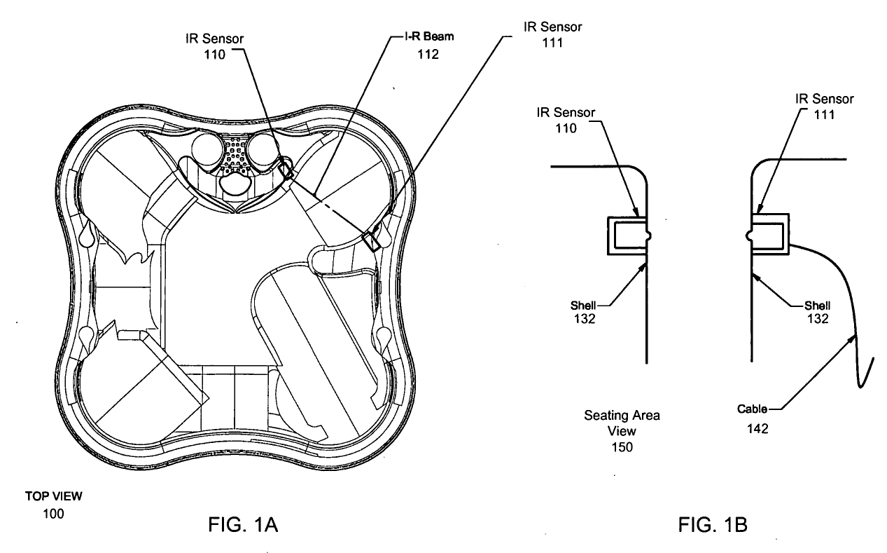

FIG. 1A shows a diagram of a top view of a spa 100 with multiple sensors 110, 111 at a seating area of the spa. A spa user in the seating area can interrupt the infrared beam 112 to control spa functions. The spa functions may include controlling a flow of the water, a heating of the water, a direction of water flow, and accessories of the spa, such a volume of a sound system. In one implementation, a spa user may move a body part, such as a hand or foot, across the beam to interrupt the beam. In one implementation, a spa user may swipe their hand across the beam's path a number of consecutive times to control the flow of the water out of the water jets around the seating area. For example, the spa user may interrupt the beam's path once to turn on water jets for a low level of water flow, interrupt the beam's path a second time (i.e., swipe a hand across the beam a total of two consecutive times) to increase the water jets to a medium level of water flow, interrupt the beam's path a third time (i.e., swipe a hand across the beam a total of three consecutive times) to increase the flow out of the water jets to a high level of water flow, and interrupt the beam's path a fourth time (i.e., swipe a hand across the beam a total of four consecutive times) to turn off the water jets and cease the corresponding water flow.

FIG. 1B shows a side view of the seating area 150 (not to scale). The sensors 110, 111 can be installed into a wall of the spa shell 132. In one implementation, an infrared sensor 110 can serve as the sender component and another infrared sensor 111 can serve as the receiver component. The beam target areas are the sending and receiving areas of the spa where the beam is sent and received.

The electrical components of the sensors 110, 111 can be located behind the wall of the spa shell 132. A cable 142 can couple the receiver component to one or more spa control units to send a signal from the receiver component to at least one of the spa control units. When a user interrupts the beam, a state of a previous signal is changed. For example, if a signal from the receiver unit has a low state, then the state of the signal sent from the receiver unit after the beam is broken will be a high state. When the beam is broken at a subsequent time, the subsequent signal sent from the receiver component can return from the high state to a low state. The signal sent from the receiving component may control various “on” and “off” functions, and may be translated into a step function in a control unit. When the signal received is high, the step function can be high, and when the signal received is low, the step function can be low.

In one implementation, electrical components associated with the sensors may be positioned directly behind the sender and receiver components. In another implementation, electrical components associated with the capacitive sensors 110 may be coupled to a central spa control system, in which multiple sensors can be coupled to control spa functions. The central spa control system may be located behind the wall of the spa shell and isolated from the corrosive environment of being near the water in the spa. In one implementation, the central spa control system may be implemented on a personal computer (PC)—type board.

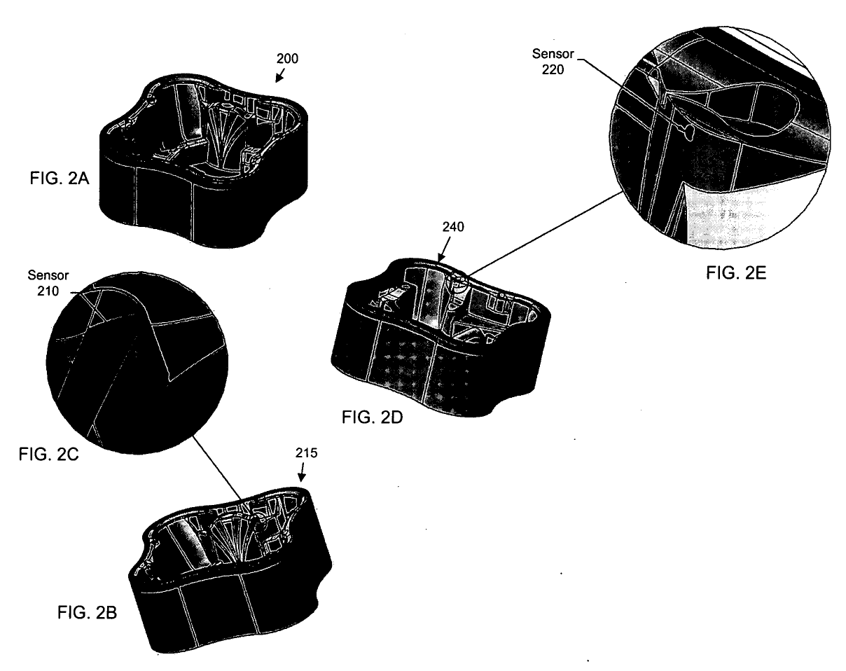

FIGS. 2A-2E illustrate various locations of sensors in the spa. For the user's convenience, the sensor locations may be situated close to a seating area of the user. For spa 200 in FIG. 2A, the sensor 210 in FIG. 2C is positioned around seating area 215. In FIG. 2E, the sensor 220 is positioned around seating area 240 in FIG. 2D.

The switch may control one or more spa functions that are local to a seating area of the spa. For example, when a user sits in a spa seating area, the body of the spa user can break the beam in that area, and can activate the water jets in the area without having the spa user to touch a mechanical switch. The user can use a hand or a foot to turn the water jets on or off.

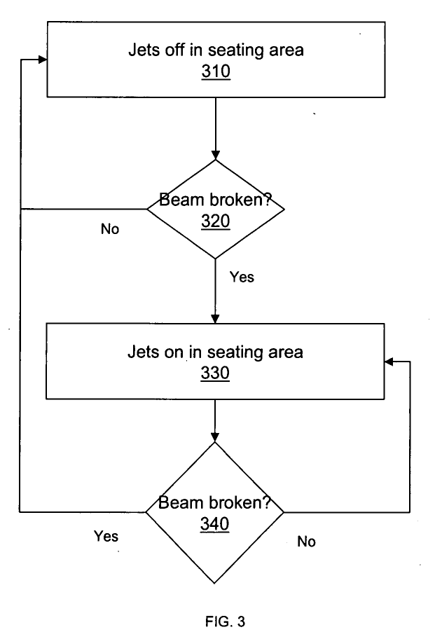

FIG. 3 is an exemplary operational flowchart for the spa switch. The water jets can be deactivated in a sitting area of the spa (block 310). When a user sits in a sitting area, a part of the body of the spa user breaks the beam (block 320), and the switch sends a signal to a control unit for the seating area's water jets to activate (block 330). When the user wants to turn off the water jets in the seating area, the user can break the beam (block 340) by either getting out of the spa seating area or by moving a body part across the beam.

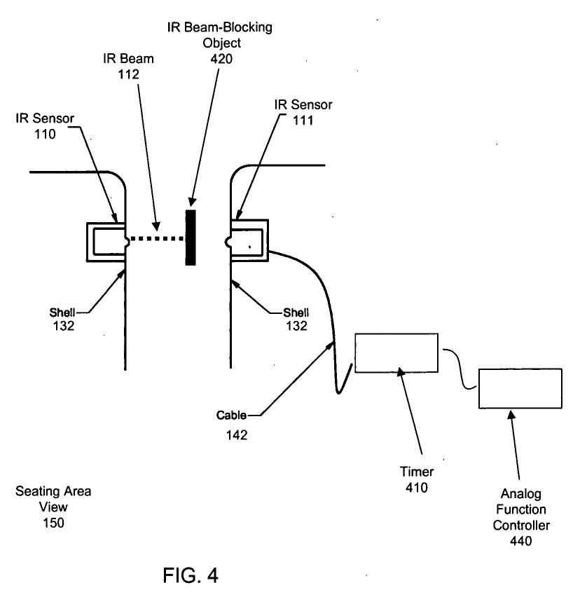

FIG. 4 shows a diagram of spa function control in which a user may control one or more spa functions in an “analog”-type manner. FIG. 4 shows that a user may place an object 420 (e.g., a hand or foot) to break the path of the infrared beam between the sensors 110, 111. A counter or timer 410 can determine how long the beam has been broken. The timer 410 is connected to an analog function controller 440 to increase or decrease a function of the spa based on an amount of time the beam is broken. For example, a user can control the functions of dimming a light in a spa or increasing a volume of a speaker for a spa sound system. The user can use the IR beam-breaking object 420 to break the beam and vary the intensity of the spa function in a manner other than a binary-type “on/off” function, or a stepping-type function (e.g., stepping up or stepping down). The spa functions that can be varied in intensity by this IR beam-breaking technique are not limited to lighting, volume control, or water flow control, but may include other spa functions, such as controlling water temperature.

The illustrations depicted in FIGS. 1-4 may be described differently than as depicted and/or stated. The illustrations shown herein are merely exemplary of the implementations of the techniques. In one example, the spa may have a switch for each sitting area of the spa. In another example, the spa may include a single switch to control spa functions. In another implementation, the sensor may be located in a “footwell” of the spa, in which the user can place their foot in the footwell to activate or deactivate spa functions. Other implementations may be within the scope of the following claims.

What is claimed is:

1. A spa control system comprising:
a spa shell;
a sender device located at a target sender area of the spa shell, the sender device being operable to send an infrared beam;
a receiver device located at a target receiver area of the spa shell, the sender device being operable to receive the infrared beam;
receiver electronics coupled with the receiver device, and are operable to transmit a signal when a path of the infrared beam is interrupted; and
one or more control units of the spa to receive the signal and to adjust a function of the spa according to the signal received.

2. The system in accordance with claim 1, wherein the one or more control units comprise a control unit to adjust water flow.

3. The system in accordance with claim 1 wherein the one or more control units comprise a control unit to adjust water volume.

4. The system in accordance with claim 1, wherein the receiver device is coupled with a personal computer-type (PC-type) board.

5. The system in accordance with claim 1, wherein a footwell area of the spa comprises the target sender area of the spa shell and the target receiver area of the spa shell.

6. The system in accordance with claim 1, wherein the path of the infrared beam between the target device and the sender device is to be interrupted at a seating section of the spa.

7. The system in accordance with claim 1, wherein the receiver electronics are configured to change a state of the signal when the path of the infrared beam is interrupted.

8. The system in accordance with claim 1, wherein the one or more control units of the spa are configured to receive the signal and to adjust multiple functions of the spa according to the signal received.

9. The system in accordance with claim 1, further comprising:
a timing device to determine an amount of time the path of the infrared beam has been interrupted; and
an analog function controller coupled with the timing device, wherein the analog function controller is operable to vary an intensity of the one or more control units based on the amount of time the path of the infrared beam has been interrupted.

10. The system in accordance with claim 9, wherein the analog function controller is operable to increase or decrease the intensity of one or more functions of the spa.

11. The system in accordance with claim 10, wherein the one or more functions of the spa comprise a volume of a spa speaker, a lighting intensity of a spa light, a water flow control, a water volume level, and a water temperature.

12. The system in accordance with claim 1, wherein the spa function comprises any of a volume of a spa speaker, a lighting intensity of a spa light, a water flow control, a water volume level, and a water temperature.

13. A method to control a spa, the method comprising:
forming an infrared beam across an area of the spa;
receiving user input to adjust at least one spa function, wherein the user input comprises an interruption of a path of the infrared beam;
converting the user input into a signal;
sending the signal to a controller unit located inside of a spa shell; and
adjusting the at least one spa function based on the received user input.

14. The method in accordance with claim 13, wherein the infrared beam is configured to be interrupted by an object breaking the path of the infrared beam across the area of the spa.

15. The method in accordance with claim 13, wherein a current signal sent to the controller unit comprises a different state from a previous signal sent.

16. The method in accordance with claim 13, wherein the beam is formed across a sitting area of the spa.

17. The method in accordance with claim 13, wherein the adjusting comprises adjusting any of a water flow and a water volume.

18. The method in accordance with claim 13, wherein the user input comprises interrupting the path of the infrared beam a number of consecutive times to control a flow of the water out of water jets around a seating area.

19. The method in accordance with claim 18, wherein the user input further comprises:
interrupting the path of the infrared beam a first time to turn on water jets for a low level of water flow;
interrupting the path of the infrared beam a second time to adjust the water jets to a medium level of water flow;
interrupting the path of the infrared beam a third time to adjust the water jets to a high level of water flow; and
interrupting the path of the infrared a fourth time to turn off the water jets.

20. An apparatus to control one or more spa operations, the apparatus comprising electrical components operable to:
detect whether an infrared beam formed across an area of a spa is interrupted;
convert the detected infrared beam interruption into a signal;
send the signal to a spa control unit; and
control a spa control unit using the signal.

21. The apparatus in accordance with claim 20, wherein the signal comprises a different state from a previous signal.

22. The apparatus in accordance with claim 20, wherein the spa control unit comprises a water volume control unit.

23. The apparatus in accordance with claim 20, wherein the spa control unit comprises a water flow control unit.

24. The apparatus in accordance with claim 20, wherein the water flow control unit comprises water jet controls.

25. The apparatus in accordance with claim 20, wherein the infrared beam is formed between an infrared sender unit on the spa and an infrared receiver unit on the spa.

26. The apparatus in accordance with claim 25, wherein the infrared beam is interrupted when the infrared receiver unit does not receive the infrared beam from the infrared sender unit.

27. The apparatus in accordance with claim 25, wherein the infrared receiver unit comprises electronics configured to convert the detected infrared beam interruption into the signal.
